(19) United States
(12) Patent Application Publication
(10) Pub. No.: US 2012/0216048 A1
(43) Pub. Date: Aug. 23, 2012

(54) SYSTEM, METHOD AND COMPUTER PROGRAM PRODUCT FOR APPLICATION-AGNOSTIC AUDIO ACCELERATION

(76) Inventors: Nikos Kaburlasos, Lincoln, CA (US); Devon Worrell, Folsom, CA (US)

(21) Appl. No.: 13/029,661

(22) Filed: Feb. 17, 2011

(51) Int. Cl. G06F 21/00; G10L 19/00

(52) U.S. Cl. 713/189; 704/500; 704/E19.001

(57) ABSTRACT

Methods, systems and computer system products to allow audio decryption and decoding to be performed on a graphics engine instead of on a host processor. This may be accomplished without having to modify media application software. A down codec function driver exposes a down codec to a media application, which may then send encrypted and encoded audio data to the down codec function driver. The down codec function driver may then redirect the audio data to a graphics driver. The graphics driver may then pass the audio data to a graphics engine. The graphics engine may then decrypt and decode the audio data. The decrypted and decoded audio data may be returned to the graphics driver, which may then send the decrypted and decoded audio data to the function driver. The function driver may then pass the decrypted and decoded audio data to the down codec for rendering.

### BACKGROUND

Media applications today typically perform audio decode on a host processor, which may require significant central processing unit (CPU) cycles, especially in the case of premium audio. This necessarily increases power consumption by the host processor. Measurements have shown that decoding DTS HD Master audio, for example, may add ˜0.5W to CPU power requirements during Blu-ray playback.

A separate graphics engine, however, may have the required signal processing logic (e.g., multiply-accumulate) that could be used to decode an audio stream in addition to decoding the video stream. A graphics engine core may process media workloads more efficiently (with respect to power consumption) than general-purpose CPU cores. Processing video frames on a graphics engine can save multiple watts of CPU power compared to processing the same frames on the host. A graphics engine may be capable of executing tens or hundreds of parallel threads, which would allow the completion of parallelizable workloads in a much shorter period of time (compared to executing the same workloads on the host), allowing the overall CPU package to enter sleep states more frequently, therefore saving CPU power. A high degree of parallelism may be possible when processing premium audio.

One scheme that could take advantage of a graphics engine for audio processing would entail approximately duplicating, for the audio path, the software architecture that may already be in place for video. But this would create the burden of having to modify media applications so that they can perform audio decoding on the graphics engine, along with video decoding.

### BRIEF DESCRIPTION OF THE DRAWINGS/FIGURES

FIG. 1 is a block diagram illustrating a media processing architecture in which an embodiment may operate.

FIG. 2 is a block diagram illustrating the components and data flow of an embodiment.

FIG. 3 is a block diagram illustrating the computing context of an embodiment.

FIG. 4 is a flow chart illustrating the processing of an embodiment.

FIG. 5 is a flow chart illustrating the transfer of audio data to a graphics engine, according to an embodiment.

FIG. 6 is a flow chart illustrating the receipt, by a down codec function driver, of decrypted and decoded audio data from the graphics engine, according to an embodiment.

In the drawings, the leftmost digit(s) of a reference number identifies the drawing in which the reference number first appears.

### DETAILED DESCRIPTION

An embodiment is now described with reference to the figures, where like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

Disclosed herein are methods, systems and computer program products with which audio decryption and decoding may be performed on a graphics engine instead of on a host processor. This may be accomplished as described below, without having to modify the media application program(s).

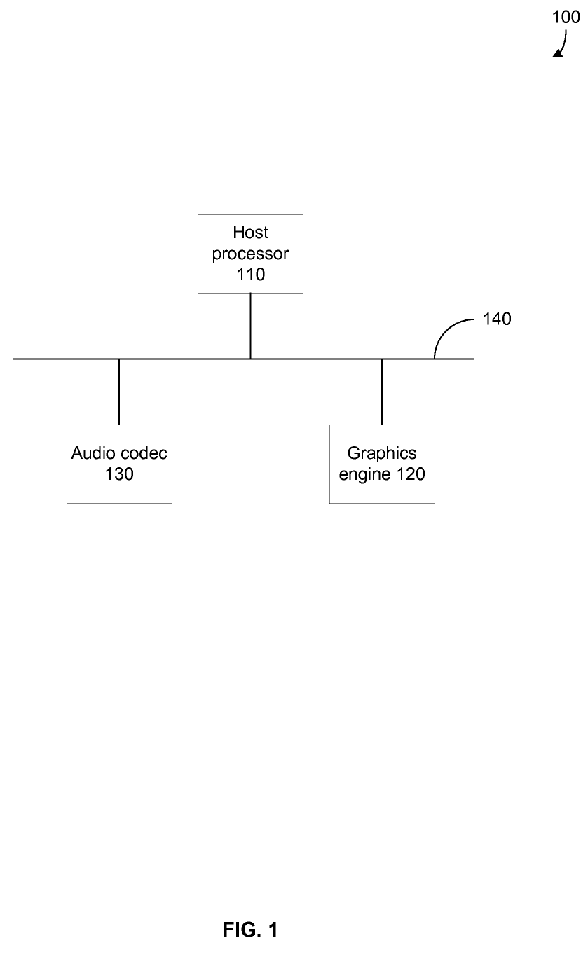

An embodiment of the system described herein may operate in the context of an architecture illustrated in FIG. 1. Such an architecture 100 may include a host processor 110. The processor 110 may be in communication with a graphics engine 120. The graphics engine 120 may typically be used to perform graphics processing. As will be described in greater detail below, graphics engine 120 may be used to perform audio processing as well, according to an embodiment. The illustrated architecture may also include a down codec 130. In an embodiment, the down codec 130 may be a component that receives decoded audio samples and renders the audio, thereby driving one or more output devices, such as speakers or headphones. The host processor 110, the graphics engine 120, and the down codec 130 may communicate via a communications infrastructure 140. In an embodiment, communications infrastructure 140 may take the form of a bus, for example.

In embodiments, the invention may be incorporated into a media system. For example, embodiments may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, or other stationary or portable information appliance.

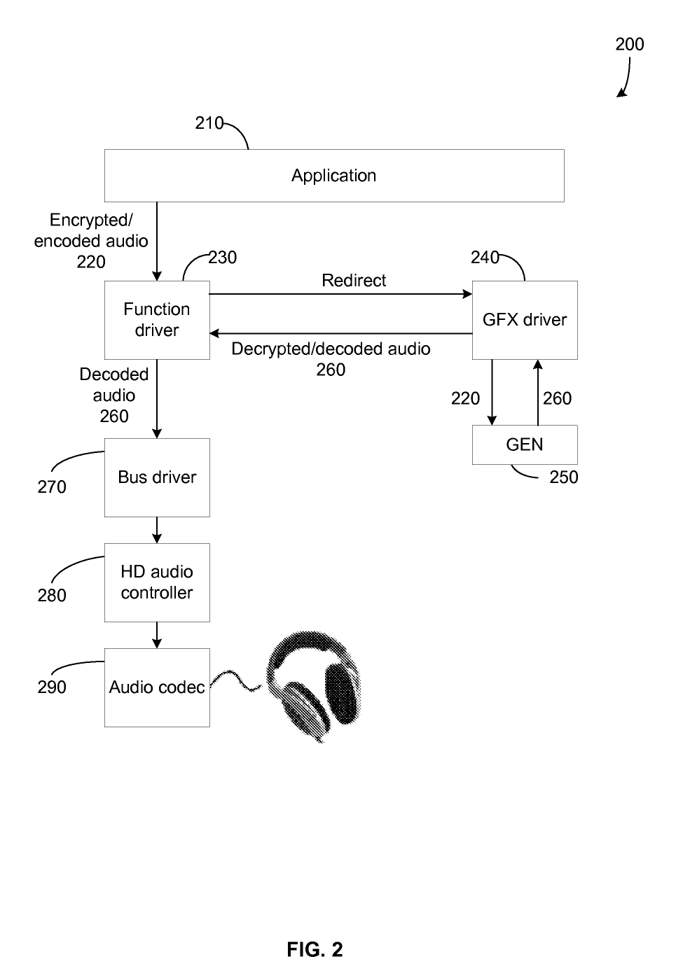

FIG. 2 is a block diagram illustrating the system 200 described herein, according to an embodiment. A down codec function driver 230 may first expose a down codec 290 to a media application 210. The media application 210 may then send encrypted and encoded audio data 220 to the down codec function driver 230. The down codec function driver 230 may then redirect the audio data 220 to a graphics (GFX) driver 240. The graphics driver 240 may then pass the audio data 220 to a graphics engine 250. In the illustrated embodiment, the graphics engine 250 may be an Intel Graphics Engine GEN (available from Intel Corp., Santa Clara, Calif.), for example and without limitation. In alternative embodiments, alternative graphics engines may be used.

The graphics engine 250 may then decrypt and decode the audio data. The decrypted and decoded audio data 260 may then be returned to the graphics driver 240, which may then send the decrypted and decoded audio data 260 to the down codec function driver 230. The down codec function driver 230 may then pass the decrypted and decoded audio data 260 to the down codec 290 for rendering. In the illustrated embodiment, the decrypted and decoded audio data 260 may be sent to the down codec 290 via a bus driver 270 and an audio controller 280.

One or more features disclosed herein may be implemented in hardware, software, firmware, or combinations thereof, including discrete and integrated circuit logic, application specific integrated circuit (ASIC) logic, programmable gate arrays, and/or microcontrollers, or may be implemented as part of a domain-specific integrated circuit package, or a combination of integrated circuit packages. The term software, as used herein, refers to a computer program product including a non-transitory computer readable medium having computer program logic stored therein to cause a computer system to perform one or more features and/or combinations of features disclosed herein.

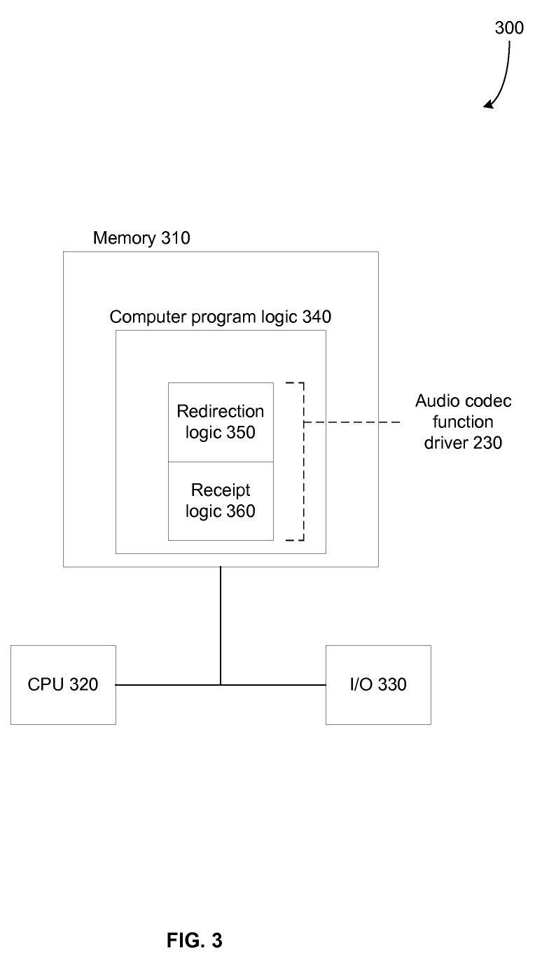

In an embodiment, the down codec function driver 230 may be implemented as software or firmware. Such a software or firmware embodiment is illustrated in the context of a computing system 300 in FIG. 3. System 300 may include a central processing unit (CPU) 320 and a body of memory 310 that may include one or more non-transitory computer readable media that may store computer program logic 340. Memory 310 may be implemented as a read-only memory (ROM) or random access memory (RAM) device, for example. CPU 320 and memory 310 may be in communication using any of several technologies known to one of ordinary skill in the art, such as a bus. Computer program logic 340 contained in memory 310 may be read and executed by CPU 320. One or more I/O ports and/or I/O devices, shown collectively as I/O 330, may also be connected to CPU 320 and memory 310. In the embodiment of FIG. 3, the down codec function driver 230 is shown as part of a larger body of computer program logic 340.

The down codec function driver 230 may include redirection logic 350. Redirection logic 350 may be responsible for redirecting audio data from a media application to the graphics driver. Down codec function driver 230 may also include receipt logic 360, which may be responsible for receiving decrypted and decoded audio data from the graphics engine and forwarding this data to the down codec for rendering.

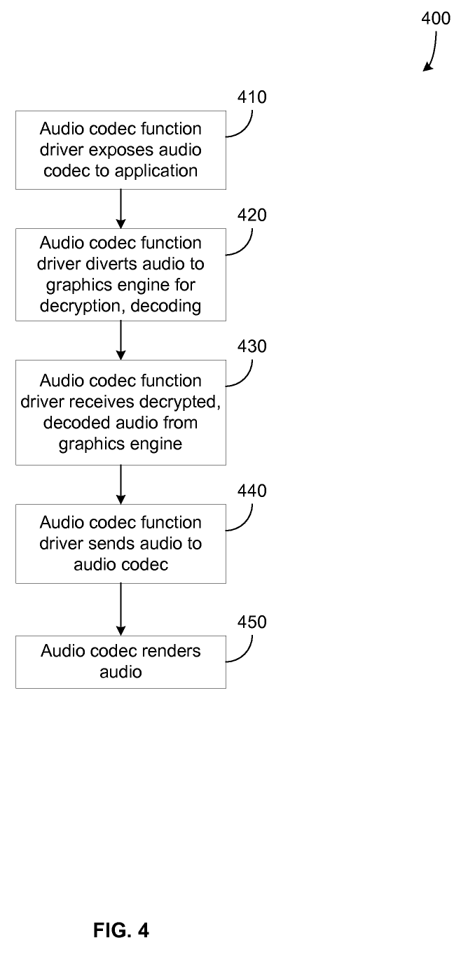

Processing of the system described herein may be performed as illustrated in FIG. 4, according to an embodiment. At 410, the down codec function driver may expose the down codec to the media application. At 420, the down codec function driver may divert encrypted and encoded audio data, received from the media application, to the graphics engine for decryption and decoding. In an embodiment, this audio decryption may use the same key used for video decryption purposes. At 430, after decryption and decoding are completed, the down codec function driver may receive the decrypted and decoded audio from the graphics engine. At 440, the down codec function driver may send the decrypted and decoded audio to the down codec. At 450, the down codec may render the audio.

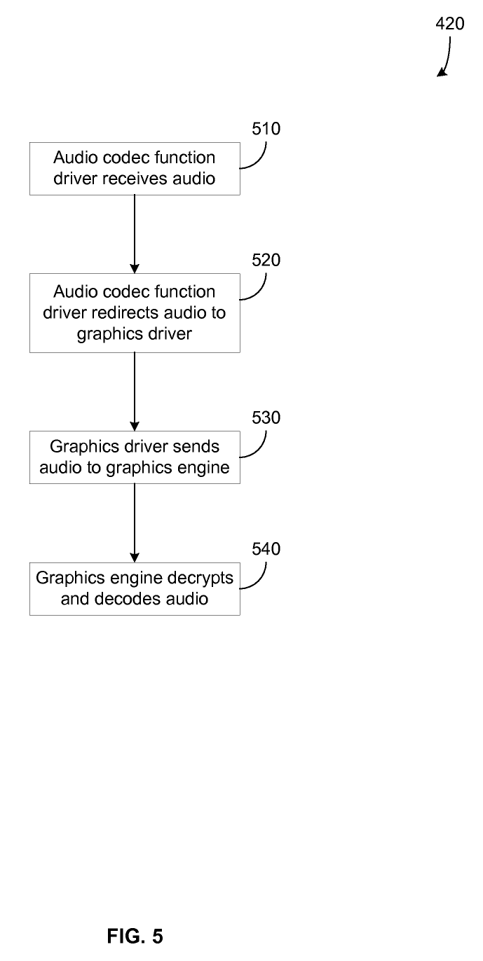

The diversion of the encrypted and encoded audio to the graphics engine (420 in FIG. 4) is illustrated in greater detail in FIG. 5, according to an embodiment. Here, the encrypted and encoded audio may be sent to the graphics engine via a graphics driver. At 510, the down codec function driver may receive the encrypted and encoded audio data. At 520, the down codec function driver may redirect this audio data to the graphics driver. At 530, the graphics driver may send the encrypted and encoded audio data to the graphics engine. At 540, the graphics engine may decrypt and decode this audio data.

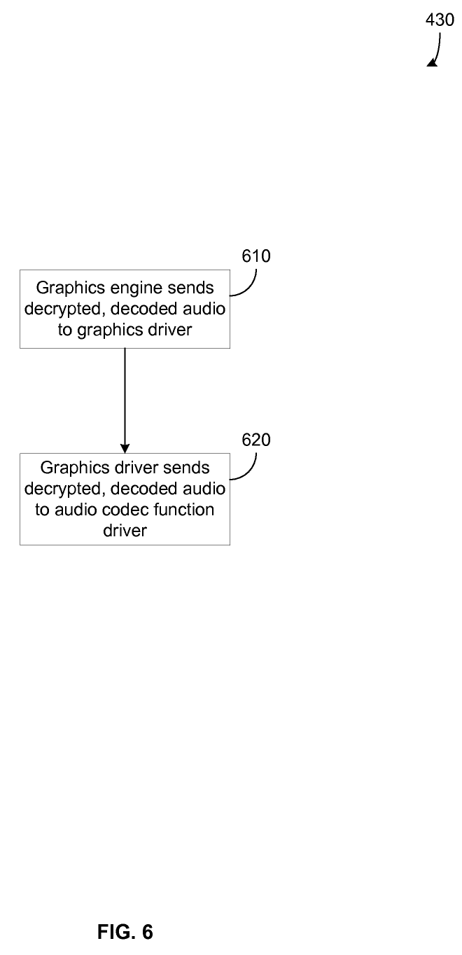

The receipt, by the down codec function driver, of the decrypted and decoded audio from the graphics engine (430 of FIG. 4) it is illustrated in greater detail in FIG. 6, according to an embodiment. At 610, the graphics engine may send the decrypted and decoded audio data to the graphics driver. At 620, the graphics driver may send the decrypted decoded audio data to the down codec function driver for rendering.

Note that after the graphics engine completes decryption and decoding, re-encryption may not be necessary. This assumes that the decrypted audio stream does not have to pass over a path that requires encryption. Examples of such as a path may be one that includes components or other infrastructure that adheres to the Peripheral Component Interconnect Express (PCIe) or Universal Serial Bus (USB) standards, or that includes a High-Definition Multimedia Inteface (HDMI) port. If, on the other hand, the down codec is attached to a bus that requires encryption, the graphics engine may either re-encrypt or down-sample the audio (to 48 kHz, for example) before passing the audio back to the down codec function driver, since down-sampled non-premium audio may not require encryption.

Moreover, by having the down codec function driver redirect the audio data to the graphics engine, and subsequently to the down codec, additional latency may result in the audio path. This decode latency may be handled by having the down codec function driver report back, to the media application, the estimated latency required for the graphics engine to decode the audio packets. This latency information may be generated by the graphics engine and provided to the down codec function driver. Such a mechanism may facilitate synchronization of video and audio streams.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method, comprising:
exposing a down codec, performed by a host processor executing a down codec function driver; and
diverting audio data to a graphics engine, performed by the host processor executing the down codec function driver.

2. The method of claim 1, wherein said diverting comprises:
redirecting the audio data to a graphics driver, performed by the host processor executing the down codec function driver;
sending the audio data to the graphics engine, performed by the graphics driver; and
decrypting and decoding the audio data, performed by the graphics engine.

3. The method of claim 1, further comprising:
receiving, by the host processor executing the down codec function driver, the audio data in decrypted, decoded form from the graphics engine.

4. The method of claim 3, wherein said receiving comprises:
receiving, by the host processor executing the down codec function driver, the decrypted, decoded audio data from a graphics driver, which received the decrypted, decoded audio data from the graphics engine.

5. The method of claim 1, further comprising:
sending the decoded, decrypted audio information to the down codec, performed by the host processor executing the down codec function driver.

6. The method of claim 5, further comprising:
rendering the decrypted, decoded audio data, performed by the down codec.

7. A computer program product including a non-transitory computer readable medium having computer program logic stored therein, the computer program logic including:
logic to cause a host processor to divert audio data to a graphics engine for decrypting and decoding.

8. The computer program product of claim 7, wherein said logic to cause the host processor to divert audio data comprises:
logic to cause the host processor to redirect the audio data to a graphics driver, which then sends the audio data to the graphics engine.

9. The computer program product of claim 7, further comprising:
logic to cause the host processor to receive decrypted, decoded audio data from the graphics engine.

10. The computer program product of claim 9, wherein said logic to cause the host processor to receive the decrypted, decoded audio data comprises:
logic to cause the host processor to receive decrypted, decoded audio data from the graphics driver, which received the decrypted, decoded audio data from the graphics engine.

11. The computer program product of claim 9, further comprising:
logic to cause the host processor to send the decoded, decrypted audio information to a down codec for rendering.

12. A system, comprising:
a host processor; and
a memory in communication with said host processor, wherein said memory stores a plurality of processing instructions configured to direct said host processor to divert audio data to a graphics engine for decryption and decoding.

13. The system claim 12, wherein said instructions to divert audio data comprises instructions configured to direct the host processor to redirect the audio data to a graphics driver, which then sends the audio data to the graphics engine.

14. The system claim 12, wherein said memory further stores a plurality of processing instructions configured to direct said host processor to receive decrypted, decoded audio data from the graphics engine.

15. The system claim 14, wherein said instructions to receive the decrypted, decoded audio data from the graphics engine comprises instructions configured to direct the host processor to receive decrypted, decoded audio data from the graphics driver, which received the decrypted, decoded audio data from the graphics engine.

16. The system claim 12, wherein said memory further stores a plurality of processing instructions configured to direct said host processor to send the decoded, decrypted audio information to a down codec for rendering.
